(19) United States
(12) Patent Application Publication
(10) Pub. No.: US 2026/0257431 A1
(43) Pub. Date: Sep. 3, 2026

(54) DEVICE FOR UNWINDING A CARBON FIBER BOBBIN

(71) Applicant: COMMISSARIAT A L'ENERGIE ATOMIQUE ET AUX ENERGIES ALTERNATIVES, PARIS (FR)

(72) Inventors: Christophe MAGNIER, MONTS (FR); Stéphane VILLALONGA, MONTS (FR); Emmanuel FLOUVAT, ARGENTAN (FR)

(73) Assignee: COMMISSARIAT A L'ENERGIE ATOMIQUE ET AUX ENERGIES ALTERNATIVES, PARIS (FR)

(21) Appl. No.: 18/557,108

(22) PCT Filed: Apr. 26, 2022
(86) PCT No.: PCT/FR2022/050792

§ 371 Date: Oct. 1, 2025

(30) Foreign Application Priority Data
Apr. 26, 2021 (FR) 2104315

(51) Int. Cl. B29C 70/32; B29C 70/56; B29K 307/04; F17C 1/00

(52) U.S. Cl. CPC B29C 70/32; B29C 70/56; F17C 1/00; B29K 2307/04; F17C 2203/0663; F17C 2209/2163; F17C 2209/232; F17C 2221/012

(57) ABSTRACT

The invention relates to a device (36) for unwinding at least one roving (M) from a bobbin (38) comprising:
a plate (42) carrying at least one reel holder (56) extending along an axis (B) substantially perpendicular to the plate (42) and intended to receive a reel (38) capable of rotating about the said axis of the reel holder (56);
a head (44) for depositing said at least one roving (M) from said bobbin (38), the depositing head (44) being carried by the plate (42) and extending along an axis parallel to the axis (B) of said bobbin holder (56) and in a direction opposite to said bobbin holder (56);
an orifice formed through the plate (42) and traversed by the axis of the dispensing head (44) so as to allow the passage of said at least one wick (M) from a bobbin (38) to the dispensing head
and in which the plate (42) is rotatable about the axis (F) of the head for depositing on the frame.

This document relates to a device for unwinding one or more bobbin with a view to winding at least one strand of a bobbin around an object such as a hollow mandrel intended to form a reservoir which can, for example, receive pressurised fluid, such as, in particular, gaseous hydrogen. This document also relates to a filament winding installation.

### PRIOR ART

Filament winding is a process for moulding composite materials into parts with an axis of revolution (cylinder, cone, etc.). This process is suitable for mass production and is mainly used to manufacture parts subject to high mechanical stress (tanks, pipes, etc.).

FIG. 1 shows a filament winding installation 10 using known technology, comprising a mandrel 12 rotatably mounted on a frame 14 about a substantially horizontal longitudinal axis A. The installation 10 comprises a dispenser 16 movable in translation along the longitudinal axis A and carrying a plurality of bobbins 18 extending substantially perpendicularly to a panel of the dispenser and substantially horizontally. Each dispenser 18 comprises a strand 20, which are brought together side by side at a laying head 22 so as to form a sheet. The laying head 22 is attached to the dispenser 16 by means of a carriage 24 which can be moved in translation along the longitudinal axis A.

In some configurations (not shown), the laying head can also move in a direction transverse to the axis of the mandrel, rotate about said transverse axis, pivot about the longitudinal axis, or even move on the vertical axis.

Before the filament winding installation is started up, the sheet is attached to the mandrel. Tensioners of the dispenser are activated to put the fibers under tension, limit the build-up and compact the successive layers deposited as well as possible. A layer is defined by a winding that enables the sheet to be deposited over the entire surface of the mandrel that is to be covered. It is possible to create a helical type layer with the sheet deposited by forming helices in order to cover the entire surface of the cylinder and the desired areas in the hemispherical bottoms. It is also possible to create a circumferential layer where the sheet is deposited almost transversely to the axis of the mandrel over all or part of the cylindrical area of the mandrel.

Structuring by filament winding enables a succession of helical and/or circumferential layers to be stacked in order to achieve the desired mechanical performance of the object. In general, the machine is controlled by a numerical controller. This numerical control is often programmed by an operator using software dedicated to filament winding.

Contact dispensing machines are known for dispensing short ribbons without the risk of twisting. However, these machines do not enable long continuous fibers to be laid and held under tension or axial mechanical stress in the direction of the fiber, which is imposed and regulated.

Known processes of this type are ATL (Automated Tape Layer) and AFP (Automated Fiber Placement).

The ATL process uses wide tapes (generally 100 to 300 mm). This technique can be used on large surfaces with a small radius of curvature, such as the wings of civil aircraft. The AFP process juxtaposes ribbons less than 10 mm wide and assembles up to 32 ribbons at the head end.

The main applications are the production of flat parts or parts with a large radius of curvature. The main idea is to replace the human hand in laying successive folds with defined fiber orientations.

All current systems use calibrated prepreg ribbons (fiber/resin) with a separating film between the layers on the storage bobbin. These calibrated tapes are made from unidirectional prepreg sheet that have been re-cut, with the risk of partial cutting of the reinforcement at the edges. Material costs are high here and it is necessary to have a system for winding the separation film during draping operations.

It is not possible to apply a continuous tension (or stress) in traction (in the direction of the fiber) to the strands, as the strand or strands making up the ply are cut at each end of the finished part.

To date, successive developments in the use of composite materials have been driven by the significant needs expressed in the automotive and aerospace sectors. The development of hydrogen storage technologies (at 700 bar operating pressure, for example) and the increase in gravimetric capacity (i.e. the ratio between the quantity of hydrogen stored and the mass of the container) are pushing composite materials to the limits of their use.

Traditional filament winding processes (dedicated machines) and more robotised processes (versatile machines) have never taken into account the full impact of the process in terms of loss of performance. In most cases, the bobbin support is far from the laying head and the strands pass through a large number of deflectors and rollers before arriving at the laying head. Each change of direction and/or rotation causes the roving to rub against the walls of the roller, making it possible for the roving to twist or fold back on itself. This twisting is a major source of loss of material performance due to the deterioration and/or premature breakage of some of the filaments making up a strand. In addition, when several layers are laminated, the change in geometry is conducive to the appearance of porosities or local surpluses of matrix and/or reinforcing fiber.

Contact coating machines are the only ones to provide a partial solution to this technical problem. The level of tension is zero or very low (in contrast to the filament winding technique) because contact application does not allow the material to be pre-stressed (under tension).

### SUMMARY

The present document thus proposes a device for unwinding at least one roving from a bobbin comprising:
a fixed frame;
a plate carrying at least one bobbin holder extending along an axis substantially perpendicular to the plate and intended to receive a bobbin capable of rotating about the said axis of the bobbin holder;
a laying head for laying said at least one strand from said bobbin, the laying head being carried by the plate and extending along an axis parallel to the axis of said bobbin holder and in a direction opposite to said bobbin holder;
an orifice formed through the plate and traversed by the axis of the laying head so as to allow the passage of the said at least one strand from a bobbin to the laying head; and in which the plate is rotatable about the axis of the laying head on the frame.

According to the present configuration, the laying head is made integral in rotation with a support plate for the bobbin or bobbins. The strand of each bobbin is thus fixed in the reference mark of the plate and the laying head, so that the risk of the strand twisting from its exit from the bobbin to the laying head is greatly reduced.

Simultaneous rotation of the support plate for the bobbin or bobbins and the laying head freezes the positioning of the sheet, i.e. of all the strands leaving the laying head, for example at the release rollers, whatever the angular position of the laying head. It is possible to apply an axial prestress in the direction of the fibers, i.e. an axial tension, which can be several Newtons. This drastically reduces the occurrence of twisting, friction with the walls of the roller, twisting or folding of the strand or each of the strands on itself.

It is therefore possible to continue to use a standard commercial reel without a separating film between the layers, which is less expensive than a calibrated sheet.

In addition, this combination ensures that each strand is well centred in the direction of the laying head and reduces twisting due to the arrangement of the bobbin, the presence of a roller (coupled to this bobbin oriented in this way) and the rotation of the support.

Preferably, the laying head comprises a guide system for contactless laying, for example by filament winding, of one or more sheet onto an object, said guide system comprising for example an eyelet or an assembly of rollers and/or rollers.

According to another characteristic, each bobbin holder cooperates with a deflection rod and a deflection roller, the deflection rod extending along an axis substantially perpendicular to the plate and being positioned so that a plane tangent to the rod intercepts a track of said deflection roller which has an axis of rotation substantially perpendicular to the axis of rotation of the reel holder.

In this way, the strand emerging from the deflection rod comes directly to rest on a track of the deflection roller, the strand then being returned by the said deflection roller through the orifice of the plate towards the laying head.

Preferably, the said tangent plane is substantially perpendicular to the axis of rotation of the idler.

The deflection rod can be positioned so that in operation a first portion of strand extends between the bobbin mounted on said bobbin carrier and the deflection rod and a second portion of strand extends between the deflection rod and the deflection roller, the first portion of strand and the second portion of strand forming an angle of less than 90°, preferably less than 45°.

This arrangement ensures that the strand on the bobbin is properly tensioned and further limits the formation of twists.

Each guide rod can be mounted on the plate so that it can rotate about its own axis.

The roller or rollers can be arranged opposite the opening in the tray. The roller(s) may be carried by a single support projecting from the plate and carried by the latter.

The tray carries N bobbin holders, where N is between 1 and 4. In one particular configuration, the tray comprises 4 bobbin holders.

The bobbin holders can be arranged around the opening in the tray.

Each bobbin holder can be rotatably mounted on the plate and coupled to a system for tensioning the bobbin roving when the bobbin is mounted tightly on the bobbin holder.

The present document also relates to an installation for winding at least one strand from a bobbin, the installation comprising a device as described above and a robot for moving an object intended to be covered in whole or in part by the said at least one strand from the bobbin.

The features set out in the following paragraphs can optionally be implemented independently of one another or in combination with one another:

### BRIEF DESCRIPTION OF THE DRAWINGS

Further features, details and advantages will become apparent from the detailed description below and from an analysis of the attached drawings, in which:

FIG. 1, which has already been described, is a schematic perspective view of a filament winding installation using the previous technique;

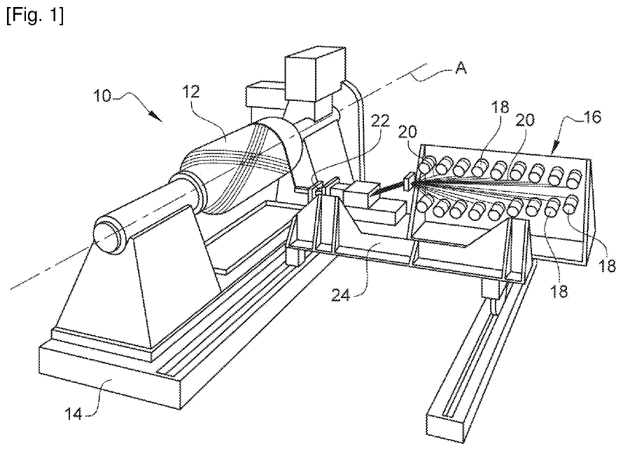

FIG. 2 is a schematic perspective view of a filament winding installation according to the present document;

FIG. 3 is a schematic view of the coil support tray from a first side, with a coil mounted on the tray;

FIG. 4 comprises a part A, called FIG. 4A, and a part B, called FIG. 4B, representing two orientations of a support and rotary drive leg for the turntable;

FIG. 5 is a similar view to FIG. 3, but without the coil mounted on the plate.

### DESCRIPTION OF HOW IT WORKS

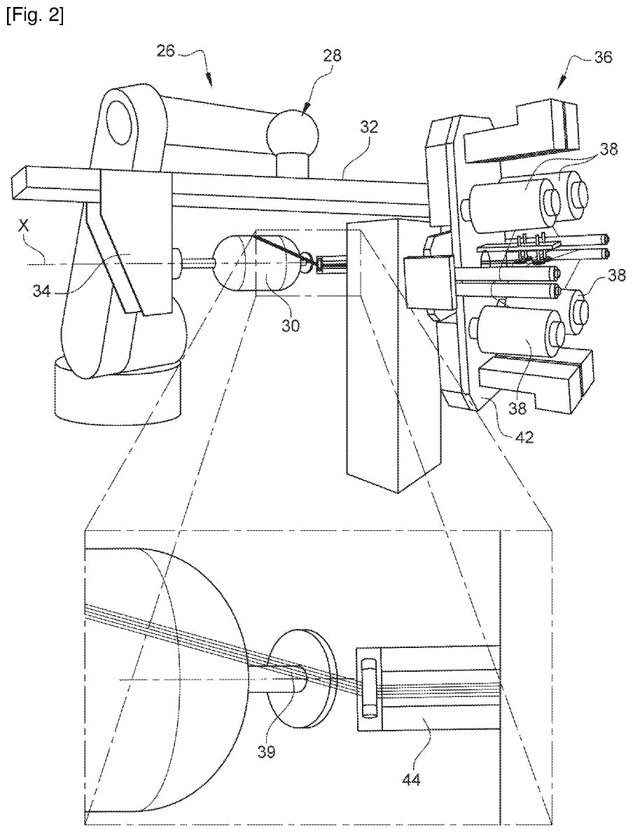

Reference is now made to FIG. 2, which illustrates a filament winding installation 26 comprising a robot 28 for moving an object 30 intended to be covered in whole or in part by one or more strands M of bobbins 38. The object in question is a hollow support 30, which may be made of metal and which is intended to form a reservoir, the mechanical strength of the reservoir at high pressures being substantially increased by depositing carbon filament strands.

The robot 28 comprises a rail 32 with two arms 34 for supporting the mandrel 30, which is mounted so that it can rotate about an axis B.

The installation 26 also includes a device 36 for unwinding one or more wicks M, each from a reel 38.

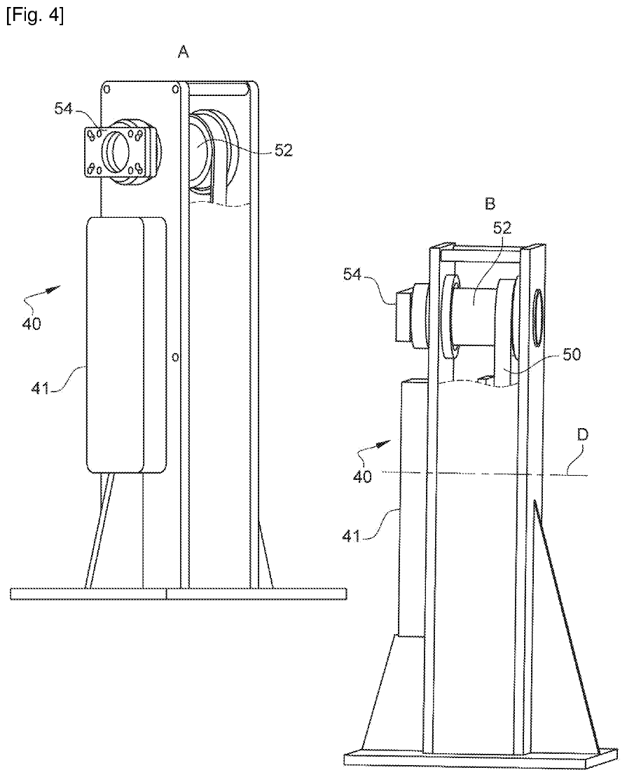

This device 36 cooperates with the aforementioned robot 28 so as to deposit a sheet 39, i.e. a plurality of strands M arranged side by side. The device 36 comprises a frame 40 having a vertical base 41 housing means for controlling and driving the rotational movement of a plate 42 and a laying head 44 (FIGS. 4A and 4B). The plate 42 and the laying head 44 are integral with each other, the laying head 44 being arranged on one side of the foot 41 and the plate 42 on the other side. The laying head 42 extends along an axis F perpendicular to the plate 42 and from a first face thereof.

The base 41 houses a motor (not shown) whose substantially horizontal axis of rotation D drives a hollow shaft 52 in rotation via a belt 50. This shaft 52 is rotatably mounted on the base 41 via appropriate bearing systems and comprises at a first end an external plate 54 for fixing to a plate of the tray 42. The shaft 52 extends along the same axis F as that of the laying head 44. At a second end, shaft 52 may also comprise another external plate for attachment to a corresponding plate on the laying head 44. Other means of rotationally coupling the laying head to the shaft 52 can also be used without departing from the object of the present invention.

The plate 42 is formed by a substantially flat plate with a first face facing the laying head 44 or the foot 41 and a second opposite face facing away from it.

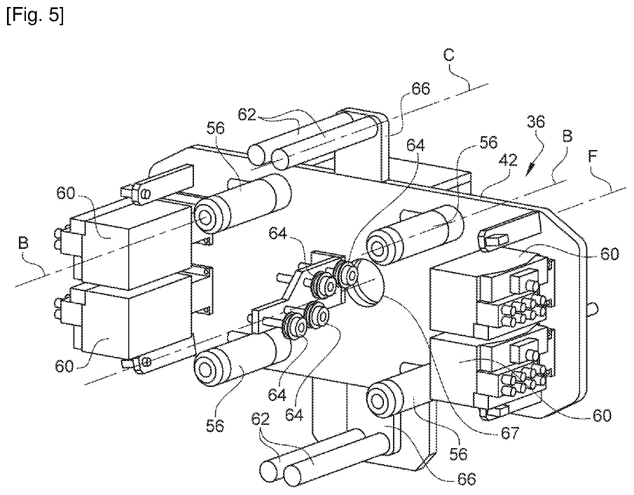

The plate 42 carries a plurality of bobbin holders 56. There are four of these in FIG. 5, but there could be more or fewer. Each reel holder 56 extends from the second face along an axis B substantially perpendicular to the plate 42 and is mounted so as to rotate about its axis B on the plate 52. Each reel holder 56 is able to receive a reel 38 which is mounted clamped on the reel holder 56. Each bobbin holder 56 is connected to a system for tensioning the roving of the bobbin 38. This tensioning system comprises a motor 60 carried by the platen and arranged on the second face of the latter, a belt coupling the motor shaft in rotation with the shaft B of the bobbin holder 56 via pulleys. Each tensioning system also comprises a tensioning roller for tensioning the belt.

It can be seen that the plate 42 comprises a central orifice 67, the bobbin holders being arranged around this orifice. This orifice 67 has an axis C which corresponds to the axis of the laying head 44 and allows the circulation of the strands from the bobbins 38 through the plate 42, through the shaft 52 of the foot 41 to the laying head 44.

As can be seen, each reel holder 56 is associated with a deflection rod 62 and a deflection roller 64.

Each deflection rod 62 comprises a hollow cylinder rotatably mounted on a support arm 66 integral with the plate 42 (Figures). The deflection rod 62 extends along an axis C substantially perpendicular to the plate 42, i.e. parallel to the axes B of the reel holders 56. Each deflection rod 62 is associated with a roller and is positioned so that a plane tangent to the rod 62 intercepts a track 64a of said deflection roller 64 with which said rod is associated (FIG. 5). More particularly, the said tangent plane of each deflection rod 62 is substantially perpendicular to the axis of rotation of the deflection roller 64 associated with Each deflection roller has an axis of rotation substantially perpendicular to the axis of rotation of the bobbin holder 56. The deflection rollers 64 are all carried by a single support projecting from the second face of the plate 42 and carried by the latter.

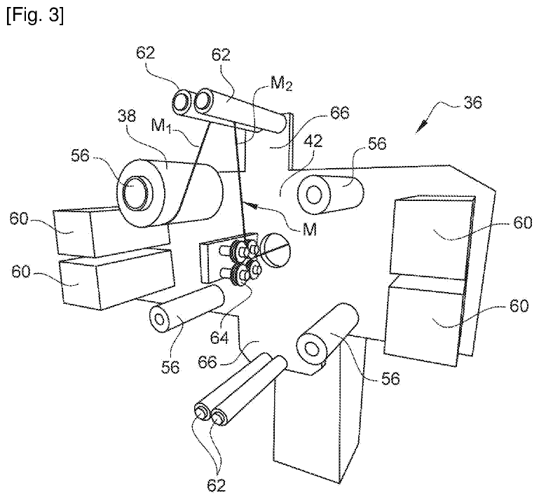

As illustrated in FIG. 3, each deflection rod 62 is positioned so that in operation a first roving portion M1 extends between the bobbin 38 mounted on said bobbin holder 56 and the deflection rod 62 and a second roving portion M2 extends between the deflection rod 62 and the deflection roller 64, the first roving portion M1 and the second roving portion M2 forming an angle a of less than 90°, preferably less than 45°.

It should be noted that the roving rotates in the plane of the plate 42 when it enters the return roller 64. In this way, the rovings from the different bobbins are arranged side by side to form a roving intended to be applied to a mandrel at the laying head.

1. Device (36) for unwinding at least one strand (M) from a bobbin (38) comprising:
a fixed frame (40);
a plate (42) carrying at least one bobbin holder (56) extending along an axis (B) substantially perpendicular to the plate (42) and intended to receive a bobbin (38) capable of rotating about the said axis of the bobbin holder (56);
a laying head (44) for depositing said at least one strand (M) from said bobbin (38), the laying head (44) being carried by the plate (42) and extending along an axis parallel to the axis (B) of said bobbin holder (56) and in a direction opposite to said bobbin holder (56);
an orifice formed through the plate (42) and traversed by the axis of the laying head (44) so as to allow the passage of said at least one strand (M) from a bobbin (38) to the laying head (44);
and in which the plate (42) is rotatable about the axis (F) of the laying head (44) on the frame.

2. Device according to the preceding claim, in which each bobbin holder (56) cooperates with a deflection rod (62) and a deflection roller (64), the deflection rod (62) extending along an axis (C) substantially perpendicular to the plate (42) and being positioned so that a plane tangent to the rod (62) intercepts a track of said deflection roller (64) which has an axis of rotation substantially perpendicular to the axis (B) of rotation of the spool holder (56).

3. Device according to claim 2, in which the said tangent plane is substantially perpendicular to the axis of rotation of the return roller (64).

4. A device according to claim 2 or 3, wherein the deflection rod (62) is positioned so that in operation a first portion of strand (M1) extends between the bobbin (38) mounted on said bobbin holder (56) and the deflection rod (62) and a second portion (M2) of roving extends between the deflection rod (62) and the deflection roller (64), the first roving portion (M1) and the second roving portion (M2) forming an angle of less than 90°, preferably less than 45°.

5. Device according to one of claims 2 to 4, in which each deflection rod (62) is mounted so as to rotate about its axis (C) on the plate (42).

6. Device according to one of claims 2 to 5, in which the roller or rollers (64) are arranged opposite the orifice of the plate (42).

7. Device according to one of the preceding claims, in which the tray carries N reel holders (56), N being between 1 and 4.

8. Device according to claim 7, in which the reel holders (56) are arranged around the orifice (67) of the plate (42).

9. Device according to one of claims 1 to 5, in which each bobbin holder (56) is rotatably mounted on the plate (42) and coupled to a system for tensioning the roving (M) of the bobbin (38) when the bobbin (38) is mounted clamped on the bobbin holder (56).

10. Installation for winding at least one roving (M) on a bobbin (38), the installation comprising a device according to one of the preceding claims and a robot for moving an object intended to be covered in whole or in part by the said at least one strand (M) on the bobbin (38).
